(19) United States
(12) Patent Application Publication
(10) Pub. No.: US 2015/0219283 A1
(43) Pub. Date: Aug. 6, 2015

(54) Tubular Light Source Device

(71) Applicant: Sagatek Co., Ltd., Taipei (TW)

(72) Inventors: Jung-Hsiang Chen, Taipei (TW); Kuan-Wen Chen, Taipei (TW)

(73) Assignee: Sagatek Co., Ltd., Taipei (TW)

(21) Appl. No.: 14/170,736

(22) Filed: Feb. 3, 2014

(51) Int. Cl. F21K 99/00; F21V 23/06; F21V 29/15; F21V 23/00

(52) U.S. Cl. CPC F21K 9/175; F21V 23/007; F21V 23/005; F21V 23/06; F21V 29/15

(57) ABSTRACT

Disclosed is a tubular light source device comprising a light tube and a light source assembly, wherein the light tube comprises a hollow cross-section, with a sector of the hollow cross-section being an inner flat portion as inner wall of the light tube. The light source assembly includes a substrate, a plurality of light emitting elements arranged on the substrate and conductive lines. The substrate is attached to the inner flat portion of the light tube, to form thermal contact with the inner wall. The light source device may further include necessary connector and controllers.

### FIELD OF THE INVENTION

The present invention relates to a light source device, especially to a tubular light source device. The present invention provides a light source device that is low cost, easy to fabricate and with high heat dissipation effects.

### BACKGROUND OF THE INVENTION

Along with the increased light emitting efficiency of the light emitting diode (LED), more and more light source devices have adopted the LED as their light source element. A variety of light source devices that use the LED has come into the market, making the LED-related applications a new industry.

In the application of LED, heat dissipation is one of the major tasks of developers. Although the LED generates lights in high efficiency, in application a transmission medium is necessary to project the lights so generated to a desired destination. For this and other reasons, in most applications the light emitting elements are accommodated in a sealed environment. Dissipation of heat generated by the LED when emitting lights is always blocked by the sealed environment.

In order to resolve the heat dissipation problem in the LED applications, many solutions have been suggested. Taiwan patent No. 1408316 disclosed a lighting instrument comprising a tubular cap extending in the direction of the LED light paths.

A flat portion is formed at one sector of the cap cross-section. A plurality of heat dissipation fins extends from the opposite surface of the flat portion. The heat dissipation structure of this invention is complicated and difficult to fabricate.

Taiwan patent No. 1409412 disclosed an LED light source device including a tubular cap that extends in the direction of an LED array. A flat portion is formed at one sector of the cap cross-section. A plurality of heat dissipation fins extends from a heat dissipation seat attached to the opposite side of the flat portion and supporting the LED array. The heat dissipation seat must first be assembled to the LED array, then to the cap. Fabrication and assembly are difficult.

Taiwan patent No. 1409406 disclosed an LED light source comprising a semi-tubular cap extending in the direction of an LED array. A mounting seat is connected to the open side of the semi-tubular. Heat dissipation fins are formed on the mounting seat. The mounting seat must be assembled with an LED array, then with the cap. This LED light source is difficult to fabricate and assemble.

Therefore, it is necessary for the industry to develop a light source device that is simple in structure, easy to fabricate and assemble and with high heat dissipation effect.

### Objectives of the Invention

One objective of this invention is to provide a light source device that is simple in structure, easy to fabricate and assemble and efficient in heat dissipation.

Another objective of this invention is to provide a tubular light source device that is simple in structure, easy to fabricate and assemble and efficient in heat dissipation.

### SUMMARY OF THE INVENTION

The tubular light source device according to this invention comprises a light tube and a light source assembly. The light tube comprises a hollow cross-section, preferably a hollow cylinder. A sector of the hollow cross-section includes an inner flat portion as inner wall of the light tube. In the preferred embodiments, the light tube has a circular outer periphery, while in other embodiments, the light tube has a polygonal outer periphery. The light source assembly includes a substrate, a plurality of light emitting elements arranged on the substrate and conductive lines connecting the plurality of light emitting elements to supply power. The substrate is attached to the inner flat portion of the light tube, to form thermal contact with the inner wall. The light source device may further include a connector attached to the light tube and in electrical connection with the conductive lines. Preferably two connectors are provided at both ends of the light tube and seal the light tube. The size, shape and contact terminal arrangements are preferably compatible to those of the standard fluorescent lamp.

In some preferred embodiments of this invention, the substrate extends to the total length of the light tube, so to enhance heat dissipation effects. Controller may be provided on the substrate and may include power controller, signal controller and modulator-demodulator circuits, and necessary leads and wires. A wireless communication chip, as well as necessary power transformer, may further be provided on the substrate. The controllers and the communication chip may also be arranged in a space defined by the connector.

The light tube may extend linearly or bend to form a folding shape, an arc shape etc. Material for the light tube is preferably glass or any material of high transparency and heat dissipation factors. The light tube may be colored, to provide filtering or decorative effects.

These and other objectives and advantages of this invention may be clearly understood from the detailed description by referring to the attached drawings.

### BRIEF DESCRIPTION OF THE DRAWINGS

FIG. 1 shows the structure of the tubular light source device of this invention.

FIGS. 2A-2E show several examples for the cross-section of the light tube.

### DETAILED DESCRIPTION OF THE INVENTION

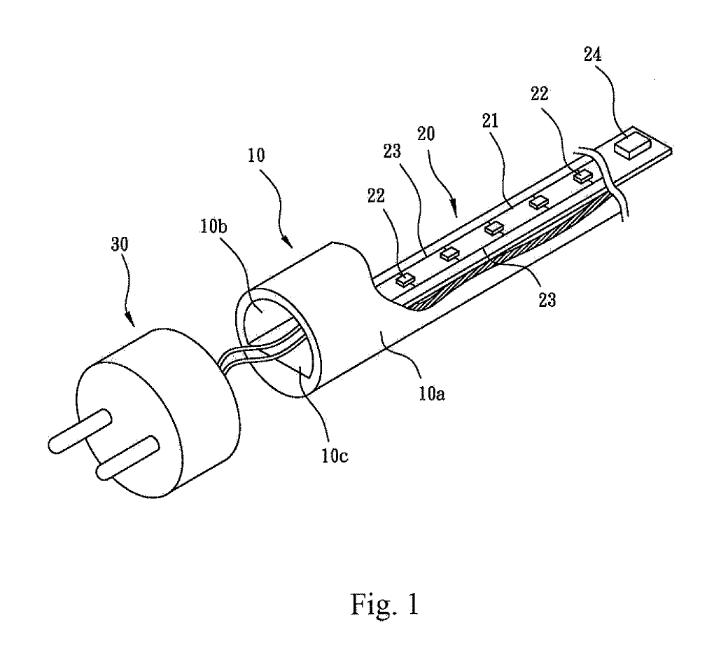

The preferred embodiments of the tubular light source device of this invention will be described in the followings. FIG. 1 shows the structure of the tubular light source device of this invention. As shown in this figure, the light source device of this invention includes a light tube 10 and a light source assembly 20. The light tube 10 generally forms a hollow cross-section and is preferably a hollow cylinder. In the embodiment shown in FIG. 1, the light tube 10 has a cross-section that includes a circular outer periphery 10a and a basically circular inner periphery 10b provided with a flat portion 10c at a sector of the inner periphery 10b. The flat portion 10c extends along the length direction of the light tube 10, preferably through the full length of the light tube 10. The light tube 10 may be made from any material with high transparency and high conductivity. If material costs, manufacture costs, transparency and thermal conductivity are taken into considerations, glass would be a preferred material for the light tube 10. This, of course, is not any technical limitation. Length of the light tube 10 is not limited, as long as the light tube 10 is easy to fabricate and install. The light tube 10 extends in its length direction linearly, as shown in FIG. 1. This, again, is not any technical limitation. The light tube 10 may extend, bend or fold to form any desirable shape in its length direction. In some embodiments of this invention, the light tube 10 forms a circle, a spiral, a polygonal or other shapes, or any of their combinations. Thickness of the light tube 10 is not limited. The light tube 10 may be transparent or colored. Any color or color combination may be applied to the light tube 10, to produce filtering and/or decorative effects.

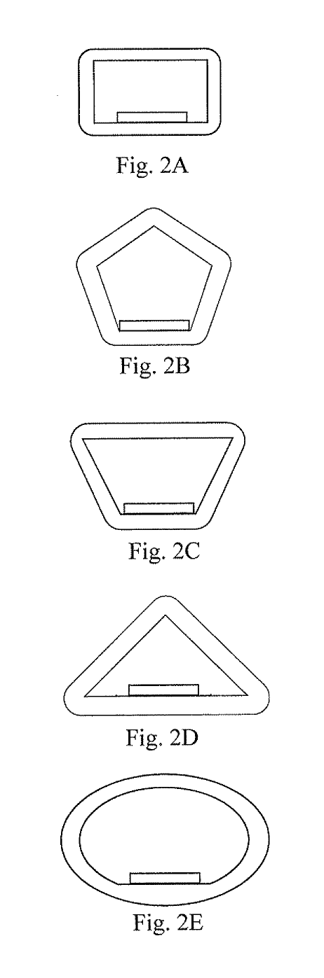

The cross-section of the light tube 10 is not limited to cylindrical, as shown in FIG. 1. Other hollow cross-sections such as hollow polygonal cross-sections may also be used in this invention, as long as a flat portion is provided in the inner peripheral of the cross-section. FIGS. 2A-2D show several examples for the cross-section of the light tube 10, wherein FIG. 2A shows a hollow rectangular cross-section, FIG. 2B shows a hollow pentagonal cross-section, FIG. 2C shows a hollow trapezoidal cross-section, FIG. 2B shows a hollow triangular cross-section. in addition, FIG. 2E shows a hollow elliptical cross-section suitable in this invention. Other types of cross-section that provides a flat portion in the inner periphery of the cross-section may be used in this invention. The cylindrical cross-section is preferable, partly because such light tube may be easily produced using the traditional fluorescent lamp fabrication equipment, after certain minor modifications.

Also as shown in FIG. 1, the light source assembly 20 includes a substrate 21, a plurality of light emitting elements 22, 22 arranged on the substrate 21 and conductive lines 23 connecting the plurality of light emitting elements 22, 22, in order to supply power to the light emitting elements 22, 22. The light emitting elements 22, 22 may be any element that generates lights. Preferably the light emitting elements 22, 22 include LEDs. The LEDs may be arranged in any suitable arrangements, such as linearly or in a matrix. The substrate 21 that carries the light emitting elements 22, 22 is attached to the inner flat portion 10c of the light tube 10, to form thermal contact with the inner wall 10c. Material for the substrate 21 is not limited but is preferably a material of high thermal conductivity, The standard printed circuit board may be used as the substrate 21. Inorganic materials such as aluminum, copper, ceramic etc. provide higher heat dissipation effects and are suitable in this invention. if the substrate 21 is made from organic materials, such as polyimide resins, glass fiber/epoxy etc., a thermal conductive pad is preferably provided between and in thermal contact with the substrate 21 and the flat portion 10c, so to transmit heat generated by the light emitting elements 22, 22 to the flat portion 10c of the light tube 10.

Control devices 24 such as power converter circuit, power controller, signal controller and modulator-demodulator circuit, as well as necessary power wires and signal lines (not shown), may also be provided on the substrate 21. In addition, a wireless transceiver (not shown) may further be provided on the substrate 21, to facilitate remote controls to the light emitting elements 22, 22 from external. If the substrate 21 is made of a high thermal conductive material, an insulation pad (not shown) is preferably provided, to thermally insulate the control devices 24 and its circuits from the substrate 21, so that heat generated by the light emitting elements 22, 22 won't damage the operation of the control devices 24. Alternatively, the power converter circuit, power controller, signal controller and modulator-demodulator circuit, as well as the wireless transceiver may be accommodated in the space defined by the connector 30 apart from the light tube 10.

Because a flat portion 10c is provided at the inner periphery of the light tube 10, the substrate 21 may be seated on the flat portion 10c and maintain close contact with the flat portion 10c. The light tube 10 is a material of high transparency and high thermal conductivity. Heat generated by the light emitting elements 22, 22 may be easily transmitted/diffused to the flat portion 10c, to the whole light tube 10, then to the environment. Heat dissipation effects of the device are thus enhanced. In addition, the flat portion 10c provides a securing surface for the substrate 21. The substrate 21 may be securely attached to the light tube 10, without the needs of an additional substrate seat or LED seat, as in the conventional art. Assembly of the light source device is easy and robust, while number of elements, material costs and assembly costs are all reduced.

The light source device may further include connectors 30 attached to both ends of the light tube and in electrical connection with the power lines 23. If two connectors 30 are provided at both ends of the light tube 10, they may seal the light tube 10. In such a case, the connectors 30 may be compatible with the traditional connector used in the standard fluorescent lamps. For this reason, the size, shape and contact terminal arrangements are preferably compatible to those of the standard fluorescent lamp. However, it is appreciated that the light emitting elements 22, 22 of this invention need not be arranged in a sealed environment. Therefore, designers may determine whether or not to seal the light tube 10 with the connector 30 according to their needs in particular applications. In addition, to arrange the connectors 30 at both ends of the light tube 10 is not any technical limitation. Designers may determine to arrange one or more connectors 30 at any position adjacent to the light tube 10. Number of the connector 30 is not limited. One or more than two connectors are also applicable, depending on conditions in the application.

Several embodiments of the invented light source device have been described above. The present invention provides a light source device that is simple in structure and easy and low cost in fabrication and assembly. The outer shape of the invented light source device is substantially identical to the conventional fluorescent lamp. Shipment, preservation and handling are easy for the light source device. The invented light source device may easily replace the existing products, without the need of modifying the application interfaces. In addition, the tubular light source device of this invention provides highly effective heat dissipation functions. High heat dissipation efficiency is obtained, without the need of additional or particularly designed heat dissipation mechanisms.

What is claimed is:

1. A tubular light source device, comprising a light tube and a light source assembly, wherein the light tube comprises a hollow cross-section, with a sector of the hollow cross-section including an inner flat portion as inner wall of the light tube, wherein the light source assembly includes a substrate, a plurality of light emitting elements arranged on the substrate and conductive lines connecting the plurality of light emitting elements to supply power and wherein the substrate is attached to the inner flat portion of the light tube, to form thermal contact with the inner wall.

2. The tubular light source device according to claim 1, wherein the light tube has a circular outer periphery.

3. The tubular light source device according to claim 1, wherein the light tube has a polygonal outer periphery.

4. The tubular light source device according to claim 1, wherein the light tube has an elliptical outer periphery.

5. The tubular light source device according to claim 1, further comprising a connector attached to the light tube and in electrical connection with the conductive lines.

6. The tubular light source device according to claim 1, further comprising two connectors attached both ends of the light tube and in electrical connection with the conductive lines, wherein the two connectors seal the light tube.

7. The tubular light source device according to claim 6, wherein size, shape and contact terminal arrangements of the connectors are compatible to those of the standard fluorescent lamp.

8. The tubular light source device according to claim 1, wherein the substrate extends to the total length of the light tube.

9. The tubular light source device according to claim 1, further comprising a controller and necessary leads and wires provided on the substrate.

10. The tubular light source device according to claim 9, further comprising a thermal insulation pad to insulate the controller and the leads and wires from the substrate.

11. The tubular light source device according to claim 5, further comprising power controller provided in a space defined by the connector.

12. The tubular light source device according to claim 6, further comprising power controller provided in a space defined by the connector.

13. The tubular light source device according to claim 1, further comprising a wireless transceiver provided on the substrate.

14. The tubular light source device according to claim 1, wherein the light tube extends linearly in length direction.

15. The tubular light source device according to claim 1, wherein the light tube bends to form a folding shape.

16. The tubular light source device according to claim 1, wherein the light tube bends to form an arc shape.

17. The tubular light source device according to claim 1, wherein the light tube is a glass tube.

18. The tubular light source device according to claim 17, wherein the light tube is a colored glass tube.

19. The tubular light source device according to claim 1, further comprising a thermal conductive pad in thermal contact with the substrate of the light source assembly and the inner wall of the light tube.
